(19) United States
(12) Patent Application Publication
(10) Pub. No.: US 2001/0053441 A1
(43) Pub. Date: Dec. 20, 2001

(54) Multi-layer composite film having a security feature

(76) Inventors: Bernd Sperlich, Walsrode (DE); Helmut Wagner, Bomlitz (DE); Willi Schwarz, Bomlitz (DE); Hans Wunderlich, Bomlitz (DE)

Correspondence Address: BAYER CORPORATION, PATENT DEPARTMENT, 100 BAYER ROAD, PITTSBURGH, PA, 15205, US

(21) Appl. No.: 09/849,718

(22) Filed: May 4, 2001

(30) Foreign Application Priority Data
May 9, 2000 (DE) 10022493.8

(51) Int. Cl. B32B 5/16

(52) U.S. Cl. 428/323; 428/516; 156/164; 156/229; 156/324; 53/396

(57) ABSTRACT

Described is a multi-layer composite film comprising, (a) a biaxially oriented polypropylene film as a base film; (b) at least one polyolefin film superposed over said biaxially oriented polypropylene film; and (c) a colorant deposited on the polyolefin film. The colorant is interposed between the biaxially oriented polypropylene film and at least one of the superposed polyolefin films, and the thickness of the multi-layer composite film ranges between 8 μm and 26 μm. Also described are a method of producing the multi-layer composite film, and a method of using the multi-layer composite film as a packaging material.

### FIELD OF THE INVENTION

The present invention relates to multi-layer composite films which comprise a security feature in order that the film, or goods produced with the film, or goods packaged in the film, are protected in a simple manner from unauthorised imitation. The present invention also relates to a process for producing said multi-layer composite films, and to the use of the multi-layer composite films for packaging purposes.

### BACKGROUND OF THE INVENTION

The production and sale of counterfeit goods constitutes a continuously increasing problem. Counterfeit products are frequently packed in a remarkably similar manner to the original goods, so as to deceive potential purchasers and make them believe that they are acquiring originals. This results in various problems. Firstly, the manufacturer of the original products loses business. Secondly, the proprietor of the rights to the product is deprived of his intellectual property. In many cases, which are even more serious, the imitations are often of inferior quality and thus inflict a considerable loss of image on the manufacturer. Moreover, inferior quality can result in claims of product liability, so that the manufacturer of the originals is obliged to prove that goods causing damage do not originate from him. For these reasons, it is desirable for original products to be marked so that it becomes possible to identify their originality.

Very different types of goods, for example, food and tobacco products, consumer goods such as compact discs and video cassettes, and spare parts for automobiles or aircraft, are typically marketed in all-round packaging. This packaging is often made of polyolefin film, paper, cardboard or composites of these materials. In order to prove the originality of the packaged goods, the all-round packaging can be used as a support medium, for security features. Thus the packaged goods themselves do not have to be provided with these features, and it is possible, for example, to provide several products made by a manufacturer of branded articles with security features which are typical of the brand without having to intervene in the course of manufacture of each individual product.

One known form of protecting originality is the use of what are termed security labels. Embossed holograms which are applied to the packaging are also used, as are security features which are applied via tear-off strips. The latter are not always desirable, because packaging machinery which is already in use is not always designed for the use of tear-off strips. Embossed holograms or security labels have to be applied in a separate operation, which results in additional work and thus in additional cost.

### SUMMARY OF THE INVENTION

The object of the present invention was therefore to incorporate a security feature in packaging in a simple manner without new additional operations becoming necessary during the manufacture of the packaging.

In accordance with the present invention, there is provided a multi-layer composite film comprising:

a biaxially oriented polypropylene film as a base film;

at least one polyolefin film superposed over said biaxially oriented polypropylene film; and

a colorant deposited on the polyolefin film,

wherein the colorant is interposed between said biaxially oriented polypropylene film and at least one of said superposed polyolefin films, and the thickness of the multi-layer composite film ranges between 8 μm and 26 μm.

Other than in the operating examples, or where otherwise indicated, all numbers expressing quantities of ingredients, reaction conditions, etc. used in the specification and claims are to be under stood as modified in all instance by the term “about.”

### DETAILED DESCRIPTION OF THE INVENTION

Both the biaxially oriented polypropylene film and the polyolefin film of the multi-layer composite film of the present invention, may each independently contain at least one of internal lubricants, anti-static additives and antiblocking agents. Internal lubricants include, for example, amides of higher aliphatic acids, esters of higher aliphatic acid esters, waxes and metal soaps, as well as polydimethylsiloxanes. The effective amount of internal lubricant typically falls within the range from 0.01 to 3% by weight, and preferably from 0.02 to 1% by weight, based on the weight of the film layer. The addition of amides of higher aliphatic acids within the range from 0.01 to 0.25% by weight, based on the weight of the film layer, is particularly suitable. One particularly suitable aliphatic acid amide is erucic acid amide.

Preferred anti-static additives that may be used in the multi-layer composite films of the present invention include, for example, alkali alkanesulphonates, polyether-modified (i.e., ethoxylated and/or propoxylated) polydiorganosiloxanes (e.g., polydialkylsiloxanes, polyalkylphenylsiloxanes and the like) and/or substantially straight-chain, saturated aliphatic tertiary amines containing an aliphatic radical comprising 10 to 20 carbon atoms which are substituted with ω-hydroxy-(C₁-C₄)-alkyl groups, wherein N,N-bis-(2-hydroxyethyl)-alkylamines comprising 10 to 20 carbon atoms, preferably 12 to 18 carbon atoms, are particularly suitable in the alkyl radical. An effective amount of antistatic agent typically falls within the range from 0.05 to 0.5% by weight, based on the weight of the film layer. Glycerol monostearate is also suitable and is typically used as an antistatic agent in an amount from 0.03% to 0.5% by weight, based on the weight of the film layer.

Suitable antiblocking agents that may be used in the multi-layer composite films of the present invention include, but are not limited to, inorganic additives such as silica, calcium carbonate, magnesium silicate, aluminum silicate, calcium phosphate and the like, and/or crosslinked polymer particles such as crosslinked polymethacrylates or crosslinked polyalkylsiloxanes and/or incompatible organic polymers such as polyamides, polyacrylates, polymethacrylates, polyesters, polycarbonates and the like. Particulate silica is a preferred antiblocking agent. The average particle size of particulate antiblocking agents typically ranges between 1 and 10 μm, and preferably between 2 and 5 μm.

The multi-layer composite films of the present invention are manufactured by a process of biaxial stretching such as simultaneous stretching or sequential stretching for example. Manufacture by sequential stretching is preferred. For this purpose, after its extrusion and solidification on a casting roll, the film may be stretched in its direction of travel (i.e., longitudinally) at a stretching ratio of 4/1 to 7/1 and at a temperature of 120° C. to 150° C. The stretching ratio in the transverse direction preferably ranges between 8/1 and 12/1, and transverse stretching of the multi-layer film is effected at a temperature between 130° C. and 170° C. Subsequent thermofixing is preferably carried out at a temperature of 1° C. to 40° C. above the transverse stretching temperature.

A colorant is deposited on the polyolefin film prior to bonding the polyolefin film to the polypropylene film. The colorant may be deposited by any desired process, e.g., by printing or spraying. Monochrome or multi-color printing can be used. Any printing process which can be used for films is suitable for this purpose. In particular, printing can be carried out by typical methods which are used for the printing of packaging, such as offset printing, screen printing, flexographic printing, UV flexographic printing or rotogravure. The colorant may be deposited on the polyolefin film either in a separate operation or directly before lamination in the same operation. The deposited feature can either be of an arbitrary form or can serve for marking the goods which are packaged in the multi-layer composite film. This marking can refer to the date of manufacture or to the place of manufacture of the goods packaged in the film, for example.

In order to improve the affinity of the film surface of the polyolefin film with the printing ink, it may be necessary to subject the film to a corona (or spray) discharge pretreatment. While not intending to be bound by any theory, it is believed that in the course of this procedure, atmospheric oxygen is incorporated in the film surface in the form of carbonyl, epoxide, ether, or alcohol groups or combinations thereof. Other methods of pretreating polyolefin films include flame, plasma and fluorine pretreatment methods.

Lamination of the polyolefin film with the polypropylene base film can be effected either on one side only of the polypropylene base film, or on both sides of the polypropylene base film. In the latter case, the polypropylene base film is enclosed or positioned between the two polyolefin films, and at least one of the polyolefin films has been provided with the colorant. For purposes of illustration, embodiments of the present invention may be represented by, but not limited to, the following sequential multi-layer composite film structures (i), (ii) and (iii). In the following representative structures: the symbol “|” indicates the interface between two layers of the multi-layer film: “PP” means polypropylene; “C” means colorant; and “PO” means polyolefin.

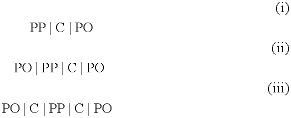

The multi-layer composite film represented by structure (i) can be described as comprising a single polyolefin film superposed over a biaxially oriented polypropylene film, wherein the colorant is interposed between the polypropylene and polyolefin films. The multi-layer composite film represented by structure (ii) can be described as comprising a biaxially oriented polypropylene film positioned or situated between two polyolefin films, wherein the colorant is interposed between the biaxially oriented polypropylene film and one of the polyolefin films. The multi-layer composite film represented by structure (iii) can be described as comprising a biaxially oriented polypropylene film positioned between two polyolefin films, wherein the colorant is interposed between the biaxially oriented polypropylene film and each of the polyolefin films

An essential feature of the multi-layer composite film according to the present invention is that after lamination with the polypropylene base film the colorant, which is deposited on the polyolefin film, is situated between these film layers (i.e., between the polypropylene and polyolefin layers). This means that the feature cannot be removed without damaging the multi-layer film and thus without visibly damaging the packaging also. Since with customary films on the market, which are printed by frontal or lateral reversal printing methods, the printing ink can easily be removed by organic solvents such as acetone for example, a distinction can be made with very simple means between the film according to the present invention and a fake. A subsequent coating of a printed film can also be removed by organic solvents.

A further essential feature of the present invention is that the composite film according to the invention is thinner than 26 μm. Thin multi-layer composite films such as these can only be produced if the thickness of at least one single film (or layer) of which the sealable multi-layer composite film consists is less than 13 μm. Sealable polyolefin films of this thickness can only be produced with difficulty, however, which makes the reproduction or forgery of the multi-layer composite film according to the present invention considerably more difficult. In one preferred embodiment, the thickness of the composite film according to the present invention ranges between 10 and 20 μm.

The multi-layer composite films according to the present invention can be produced in a particularly simple and economical manner by effecting the lamination of the polyolefin film with the polypropylene base film either: (i) before the orientation of the polypropylene base film (i.e., before the longitudinal and the transverse orientation of the polypropylene base film); or (ii) between the longitudinal and the transverse orientation of the polypropylene base film. In both these cases, the polyolefin film which is used is thicker by a factor f than it is in the composite film according to the invention. If lamination of the polyolefin film is effected before orientation of the polypropylene base film, the factor f corresponds to the overall stretching ratio of the biaxially oriented polypropylene film. In this situation, lamination is effected first, followed by either sequential or simultaneous stretching of the multi-layer film composite in the direction of machine travel and transverse to the direction of machine travel. In this situation, both the polypropylene base film and the laminated polyolefin film in the multi-layer composite film according to the present invention are biaxially oriented. In the preferred case, the polypropylene base film is oriented sequentially and lamination of the polyolefin film is effected between the longitudinal and the transverse orientations of the polypropylene base film. In this situation, the factor f corresponds to the transverse stretching ratio of the biaxially oriented polypropylene base film, and in the multi-layer composite film according to the present invention the polypropylene base film is biaxially oriented and the laminated polyolefin film is monoaxially oriented transversely to the direction of machine travel.

In a preferred embodiment of the present invention, the polyolefin film is laminated with the polypropylene base film solely by means of elevated pressure and elevated temperature, and without (or in the substantial absence of) adhesives. This has the advantage that the film has a low content of migrating substances which have a sensory effect (no effect on e.g. flavor or aroma of food); this is an important criterion, particularly if there is direct contact with food. As used herein the term “migrating substances” means substances, e.g., low molecular weight substances used in adhesive formulations, that: (i) migrate between the layers of the multi-layer composite film; and/or (ii) migrate from the multi-layer composite film into or onto items that are in contact with the multi-layer film.

In a further preferred embodiment of the present invention, the melting point or softening point of the polyolefin film is lower than the melting point of the biaxially oriented polypropylene base film. In an embodiment of the present invention, the melting point or softening point of the polyolefin film is between 20° C. and 80° C., e.g., 40° C., less than the melting point of the polypropylene base film. An embodiment is particularly preferred in which the polyolefin film comprises a polyolefin selected from propylene-ethylene copolymers, propylene-butylene-ethylene terpolymers, propylene-butylene copolymers or and mixtures thereof. The laminated polyolefin film can at the same time serve as a sealing layer for the multi-layer composite film. The thickness of the laminated polyolefin film in the multi-layer composite film according to the present invention preferably ranges from 0.5 to 15 μm, and more preferably from 0.5 to 5 μm.

In a particularly preferred embodiment of the present invention, the sprayed-on or printed colorant is a luminescent dye which absorbs UV light and emits visible light of longer wavelength, whereby a defined color imprint can be obtained on illumination with a UV lamp. The emission of light can either occur very rapidly after absorption, so that what is termed a fluorescence effect is observed, or can commence after a longer period of time, so that what is termed phosphorescence is observed. This embodiment has the advantage that the security feature is invisible in normal light so that the appearance and advertising effect of the packaging are not impaired, whilst the originality of the packaging can be proven using simple and readily available technical resources.

The appearance and color of the security feature can be modified depending on the product which is packaged in the multi-layer composite film according to the present invention. In this situation, it is possible to ensure that the product can be traced back, and to incorporate the date of manufacture and the batch number of the product or to incorporate a marking in the packaging indicating the place of manufacture, for example. This incorporated feature can either be in code (e.g., in the form of a one and/or two dimensional bar codes) can be directly readable.

The present invention further relates to a method of using the multi-layer composite film of the invention as a packaging material. Materials that may be packaged in the multi-layer composite films of the present invention include, but are not limited to, food and tobacco products, consumer goods such as compact discs and video cassettes, and spare parts for automobiles or aircraft.

The present invention is more particularly described in the following examples, which are intended to be illustrative only, since numerous modifications and variations therein will be apparent to those skilled in the art. Unless otherwise specified, all parts and percentages are by weight.

### EXAMPLES

### Example 1

A polyolefin film of thickness 10 μm, comprising: 99% of a propylene-ethylene copolymer (ethylene monomer content=4.5%), MFI=5 g/10 min (230° C./2.16 kp/cm²), density=0.90 g/cm³; 0.3% by weight of an N,N-bis-(2-hydroxyethyl)-(C₁₂-C₁₆)-alkylamine; 0.6% by weight of a polydimethylsiloxane with a density of 0.985 g/cm³ at 20° C. and a viscosity of 10⁶ m Pa s; and 0.1% by weight of silica with an average particle size of 4 μm, was printed by the flexographic printing method. The printed polyolefin film was laminated at a temperature of 80° C. on to a film of polypropylene of density 0.91 g/cm³ and with a melt index of 3.0 g/10 min at 230° C./21.6 N. Lamination was effected after stretching the film of polypropylene in its direction of travel (longitudinally) at a stretching ratio of 5/1 and at a temperature of 140° C. This multi-layer composite film was subsequently stretched (after lamination of the polyolefin film) transversely to the direction of machine travel at a stretching ratio of 10/1 and at a temperature of 160° C. Thereafter, the thickness of the overall multi-layer composite film was 16 μm. The thickness of the propylene-ethylene copolymer film component (i.e., the polyolefin layer) of the stretched multi-layer composite film was 1 μm. The printing of the multi-layer composite film was located between the polyolefin and the polypropylene layers.

### Example 2

A polyolefin film of thickness 10 μm, comprising: 99% of a propylene-ethylene copolymer (content of ethylene monomer=4.5%), MFI=5 g/10 min (230° C./2.16 kp/cm²), density=0.90 g/cm³; 0.3% by weight of an N,N-bis-(2-hydroxyethyl)-(C₁₂-C₁₆)-alkylamine; 0.6% by weight of a polydimethylsiloxane with a density of 0.985 g/cm³ at 20° C. and a viscosity of 10⁶ m Pa s; and 0.1% by weight silica with an average particle size of 4 μm, was sprayed with a printing ink which fluoresced in UV light, which was dissolved in ethyl acetate, by finely atomizing the dissolved printing ink by means of compressed air. The sprayed polyolefin film was laminated at a temperature of 80° C. on to a film of polypropylene of density 0.91 g/cm³ and with a melt index of 3.0 g/10 min at 230° C./21.6 N. Lamination was effected after stretching the film of polypropylene in its direction of travel (longitudinally) at a stretching ratio of 5/1 and at a temperature of 140° C. The multi-layer composite film (after lamination of the polyolefin film) was subsequently stretched transversely to the direction of machine travel at a stretching ratio of 10/1 and at a temperature of 160° C. Thereafter, the thickness of the overall multi-layer composite film was 16 μm. The thickness of the propylene-ethylene copolymer film component (i.e., the polyolefin layer) of the stretched multi-layer composite film was 1 μm. The fluorescent printing of the multi-layer composite film was located between the polyolefin and the polypropylene layers.

### Example 3

A polyolefin film of thickness 10 μm comprising: 99% of a propylene-ethylene copolymer (ethylene monomer content=4.5%), MFI=5 g/10 min (230° C./2.16 kp/cm²), density=0.90 g/cm³; 0.3% by weight of an N,N-bis-(2-hydroxyethyl)-(C₁₂-C₁₆)-alkylamine; 0.6% by weight of a polydimethylsiloxane with a density of 0.985 g/cm³ at 20° C. and a viscosity of 10⁶ m Pa s; and 0.1% by weight silica with an average particle size of 4 μm, was printed by the flexographic printing method. The printed polyolefin film was laminated at a temperature of 80° C. on to a film of polypropylene of density 0.91 g/cm³ and with a melt index of 3.0 g/10 min at 230° C./21.6 N. After lamination, the multi-layer composite film was stretched simultaneously in its direction of travel (longitudinally) at a stretching ratio of 5/1 and transverse to its direction of travel (transversely) at a stretching ratio of 10/1 at a temperature of 160° C. Thereafter, the thickness of the overall multi-layer composite film was 16 μm. The thickness of the propylene-ethylene copolymer film component (i.e., the polyolefin layer) of the stretched multi-layer composite film was 1 μm. The printing of the multi-layer composite film was located between the polyolefin and the polypropylene layers.

The multi-layer composite films as described in the examples herein each had an imprinted feature which was situated between the film layers and which could not be detached or removed without visibly damaging the film. Features applied subsequently (e.g., lateral reversal printing or frontal printing) can thereby be distinguished, because the latter can be removed, for example, by a suitable organic solvent. Moreover, in Example 2 the security feature was only visible when irradiated by ultraviolet light.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A multi-layer composite film comprising:
a biaxially oriented polypropylene film as a base film;
at least one polyolefin film superposed over said biaxially oriented polypropylene film; and
a colorant deposited on the polyolefin film,
wherein the colorant is interposed between said biaxially oriented polypropylene film and at least one of said superposed polyolefin films, and the thickness of the multi-layer composite film ranges between 8 μm and 26 μm.

2. The multi-layer composite film of claim 1 wherein the thickness of the multi-layer composite film ranges between 10 and 20 μm.

3. The multi-layer composite film of claim 1 wherein the melting point or softening point of the polyolefin film is lower than the melting point of the biaxially oriented polypropylene film.

4. The multi-layer composite film of claim 3 wherein the polyolefin film comprises a polyolefin selected from propylene-ethylene copolymers, propylene-butylene-ethylene terpolymers, propylene-butylene copolymers or and mixtures thereof.

5. The multi-layer composite film of claim 1 wherein the polyolefin film also serves as a sealing layer for the multi-layer composite film.

6. The multi-layer composite film of claim 1 wherein the polyolefin film has a thickness from 0.5 to 15 μm.

7. The multi-layer composite film of claim 1 wherein the colorant is a luminescent dye.

8. The multi-layer composite film of claim 1 wherein said multi-layer composite film comprises a single polyolefin film superposed over said biaxially oriented polypropylene film.

9. The multi-layer composite film of claim 1 wherein said multi-layer composite film comprises said biaxially oriented polypropylene film positioned between two polyolefin films, said colorant being interposed between said biaxially oriented polypropylene film and one of said polyolefin films.

10. The multi-layer composite film of claim 1 wherein said multi-layer composite film comprises said biaxially oriented polypropylene film positioned between two polyolefin films, said colorant being interposed between said biaxially oriented polypropylene film and each of said polyolefin films.

11. A process for producing the multi-layer composite film of claim 1 by lamination wherein the polyolefin film is laminated with the polypropylene base film before: (i) orientation of the polypropylene base film; or (ii) between longitudinal and transverse orientation of the polypropylene base film.

12. The process of claim 11 wherein the polyolefin film is laminated with the polypropylene base film by means of elevated pressure and elevated temperature.

13. The process of claim 12 wherein the polyolefin film is laminated with the polypropylene base film in the substantial absence of adhesives.

14. A method of using the multi-layer composite film of claim 1 as a packaging material.
